(19) United States
(12) Patent Application Publication
(10) Pub. No.: US 2018/0100570 A1
(43) Pub. Date: Apr. 12, 2018

(54) ACTIVE TORQUE DISPENSING APPARATUS AND METHOD FOR USING THE SAME

(71) Applicant: INDUSTRIAL TECHNOLOGY RESEARCH INSTITUTE, HSIN-CHU (TW)

(72) Inventors: Cheng-Ping Yang, Taoyuan City (TW); Jui-Tang Tseng, Hsinchu City (TW); Yung-Chi Chang, Hsinchu City (TW)

(21) Appl. No.: 15/384,671

(22) Filed: Dec. 20, 2016

(30) Foreign Application Priority Data
Oct. 7, 2016 (TW) 105132614

(51) Int. Cl. F16H 48/36; F16H 48/10; F16H 48/22

(52) U.S. Cl. CPC F16H 48/36; F16H 48/10; F16H 2048/364; F16H 2048/106; F16H 48/22

(57) ABSTRACT

An active torque dispensing apparatus and method for using the same is disclosed. The active torque dispensing apparatus includes a differential and a first actuating unit furnished thereat wherein the two ends of the differential outputs a first torque and a second torque, and the actuating unit is used for adjusting the first torque or the second torque.

### CROSS REFERENCE TO RELATED APPLICATION

This application also claims priority to Taiwan Patent Application No. 105132614 filed in the Taiwan Patent Office on Oct. 7, 2016, the entire content of which is incorporated herein by reference.

### BACKGROUND OF THE INVENTION

### 1. Field of the Invention

The invention relates to an active torque dispensing apparatus and method for using the same, and more particularly, to an active torque dispensing apparatus and method for using the same that is capable of changing the torque output to affect the rotating speed of the wheels.

### 2. Description of the Prior Art

The existing wheel vehicle has their outside wheels running paths greater than the inside ones when it comes to a turning action. Therefore, it is concerned that the wheel vehicle is unable to have smooth and precise turning action if the proceeding speed exceeds the predetermined one.

In order to have smooth and precise turning action for the wheel vehicle, an apparatus is employed to achieve the aforesaid turning action. An apparatus presented herein as a differential, is capable of transferring and allowing the inner and outer wheels to perform turning action at different speed so as to compensate the difference in wheels running paths with different rotating speed.

As the existing differential controls only the inner and outer side wheels to have the sane torque output, thereby, slipping phenomenon often occurs when it comes to wheel turning action. Therefore, there are spaces to discuss in order to lower the rotating speed of the inner wheels and to elevate the rotating speed of the outer wheels.

### SUMMARY OF THE INVENTION

In light of the disadvantages of the prior arts, the invention provides a pulsating multi-pipe heat pipe that aims to ameliorate at least some of the disadvantages of the prior art or to provide a useful alternative.

The invention is an active torque dispensing apparatus, comprising:

a differential; and

a first actuating unit furnished at the differential:

wherein the two ends of the differential is to output a first torque and a second torque, and the first actuating unit is to adjust the output of the first torque or the second torque.

The invention is an active torque dispensing apparatus, comprising:

a differential having a gear train which possesses a first input gear, a first center gear, a first output gear, a second output gear, a first output shaft, a second output shaft and a second input gear; the first input gear is engaged with the first center gear which is connected to the first input gear; both the first output gear and the second output gear are engaged with the first center gear; the first output shaft is connected to the first output gear; the second output shaft is connected to the second output gear; the second input gear is engaged with the first input gear;

a first actuating unit which is coupled with the second input gear;

wherein, the first output shaft outputs the first torque, the second output shaft outputs the second torque, the first actuating unit adjusts the first torque or the second torque.

The invention is an active torque dispensing method, comprising the following steps:

detecting the turning angle;

detecting the rotating speed of both the outer and the inner wheels;

comparing the theoretical wheel speed and the detected wheel speed;

if the judgment is that the turning is insufficient, then proceed to a controlling unit to increase the torque for the outer wheels, and in the same time lower the torque for the inner wheels; and

if the judgment is that the turning is excessive, then proceed to a controlling unit to increase the torque for the inner wheels, and in the same time lower the torque for the outer wheels.

### BRIEF DESCRIPTION OF THE DRAWINGS

The accomplishment of this and other objects of the invention will become apparent from the following description and its accompanying drawings of which:

FIG. 1 is a schematic drawing of the active torque dispensing apparatus of the first embodiment of the invention;

FIG. 2 is a schematic drawing of the differential of the first embodiment of the invention;

FIG. 3 is a schematic drawing of the differential of the second embodiment of the invention;

FIG. 4 is a schematic drawing of the active torque dispensing apparatus of the second embodiment of the invention;

FIG. 5 is a schematic drawing of the active torque dispensing apparatus of the third embodiment of the invention;

FIG. 6 is a schematic drawing of the active torque dispensing apparatus furnished at the vehicle body of the invention;

FIG. 7 is a flow chart showing the dispensing method of the active torque dispensing apparatus of the invention.

### DETAILED DESCRIPTION OF THE PREFERRED EMBODIMENT

The following descriptions are embodiments of the invention employing some particular concrete examples. Those people skilled in the art are capable of easily realizing the advantages and efficacies of the invention through the content disclosed by the patent specification of the invention.

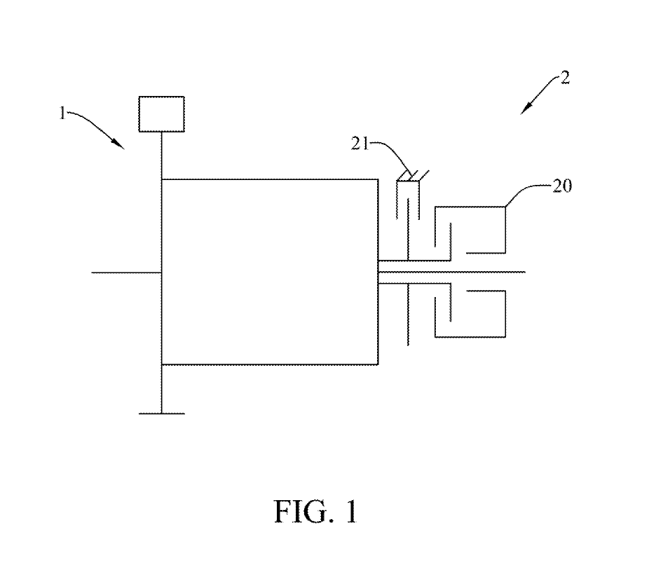

FIG. 1 is a schematic drawing of the active torque dispensing apparatus of the first embodiment of the invention. As shown in FIG. 1, the active torque dispensing apparatus of the invention includes a differential (1) and a first actuating unit (2).

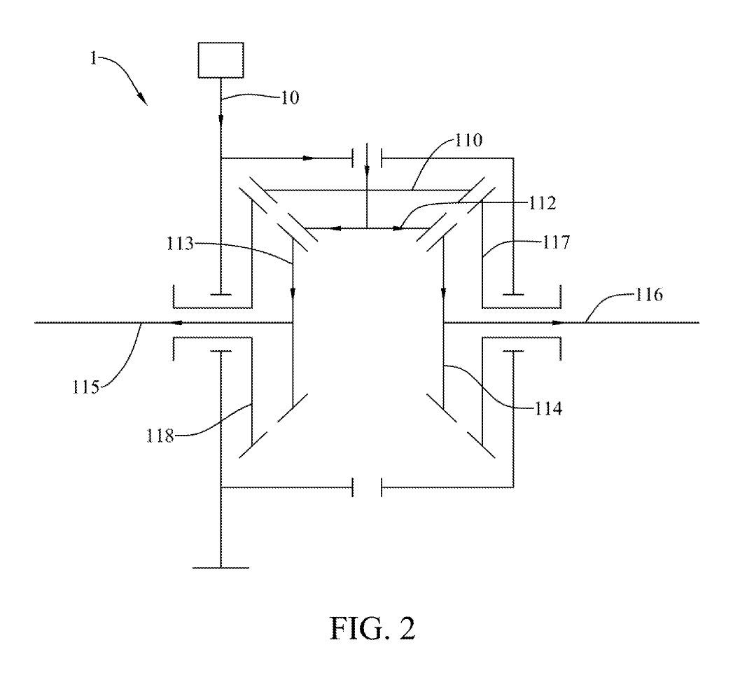

FIG. 2 is a schematic drawing of the differential of the first embodiment of the invention. As shown in FIG. 2, the differential (1) has a gear train (11) coupled to a power source (10) that drives the gear train (11). The power source (10) can be a motor or an engine.

The gear train (11) includes a first input gear (110), a first center gear (112), a first output gear (113), a second output gear (114), a first output shaft (115), a second output shaft (116), a second input gear (117) and a third input gear (118),

The first input gear (110) is coupled to the power source (10), the first center gear (112) is connected to the first input gear (110) while the first output gear (113) and the second output gear (114) is engaged to the first center gear (112). The first output shaft (115) being protruding out of the differential (1) is connected to first output gear (113) while the second input gear (117) and the third input gear (118) are engaged to the first input gear (110).

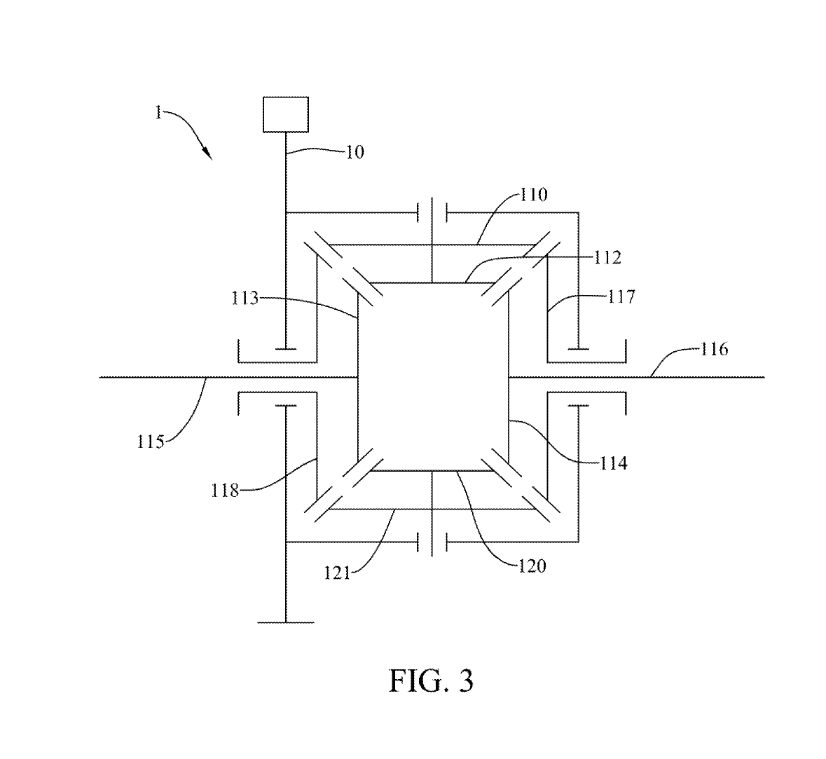

FIG. 3 is a schematic drawing of the differential of the second embodiment of the invention. As shown in FIG. 3, the gear train (11) is the first embodiment as that of the differential (1), thereby the element numerals of the first embodiment of the differential (1) are employed.

In the present embodiment, the gear train (11) further includes a second center gear (120) and a balance gear (121) where the second center gear (120) is engaged to both the first output gear (113) and the second output gear (114) while the balance gear (121) being connected to the second center gear (120) are engaged to both the second input gear (117) and the third input gear (118).

The balance gear (121) is used for balancing the second input gear (117) and the third input gear (118) while the second center gear (120) is used for balancing the first output gear (113) and the second output gear (114). Therefore, the balance gear (121) and the second center gear (120) is capable of making the output of the differential (1) more stable.

Referencing again to FIG. 2, the power source (10) provides power to the first input gear (110) to make the first input gear (110) drive the first center gear (112) which subsequently drives the first output gear (113) and the second output gear (114). The first output gear (113) drives the first output shaft (115) whose output is considered to be a first torque while the second output gear (114) drives the second output shaft (116) whose output is considered to be a second torque.

The first actuating unit (2) possesses a first power source (20) and a first brake (21). The first power source (20) being a motor is connected to the second input gear (117) while the the first brake (21) is furnished at the second output shaft (116).

Referencing to FIG. 3 by cooperating with FIG. 1, the first power source (20) provides a second power to the second input gear (117) of the differential (1). Since the second output shaft (116) has a wheel connected, the second input gear (117) provides the first input gear (110) with the second power to force the second output gear (114) reversely rotate to proceed to change the output of the second output shaft (116).

Therefore, the changing of the output of the second output shaft (116) is to affect the rotating speed of the wheels connected thereto. For instance, if the wheels connected to the second output shaft (116) are the outer wheels in a turning action, then the second power is to elevate or to lower the rotating speed of the outer wheel in a turning action to proceed to change the torque of the outer wheel while the inner wheel maintains unchanged. Similarly, if the wheels connected to the second output shaft (116) are the inner wheels in a turning action, then the second power is to elevate or to lower the rotating speed of the inner wheel in a turning action to proceed to change the torque of the inner wheel while the outer wheel remains unchanged.

In case the second power provided by the first power source (20) is still unable to lower the output of the second output shaft (116), the first brake (21) can provide a limiting effect to limit the output of the second output shaft (116). The first brake (21) and the first power source (20) can be employed separately or combined together. If only the first power source (20) is furnished, the output of the second output shaft (116) can be lowered or elevated by the first power source (20) while if only the first brake (21) is furnished, the output of the second output shaft (116) is lowered by the first brake (21).

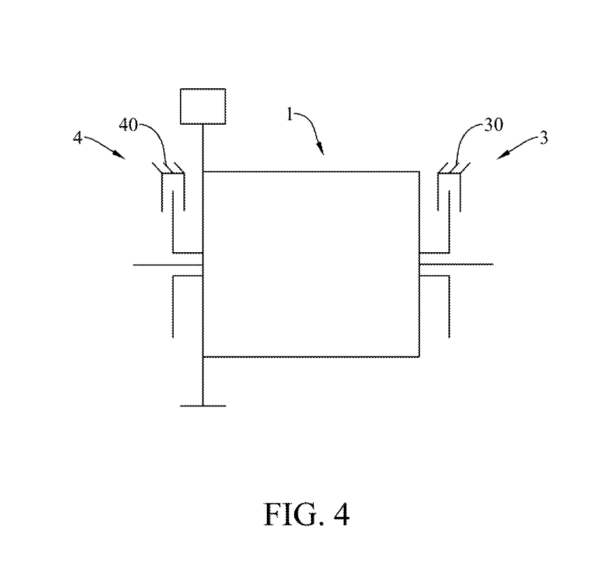

FIG. 4 is a schematic drawing of the active torque dispensing apparatus of the second embodiment of the invention. As shown in FIG. 4, the active torque dispensing apparatus of the invention includes a differential (1), a first actuating unit (3), and a second actuating unit (4).

In the present embodiment, the differential (1) employs the active torque dispensing apparatus of the first embodiment, thereby it is declared here that all the numerals will be continued to use,

The first actuating unit (3) possesses a first brake (30) that is furnished at the second output shaft (116) as shown in FIG. 2 or FIG. 3. The second actuating unit (4) possesses a second brake (40) which is furnished at the first output shaft (115) as shown in FIG. 2 or FIG. 3.

As the aforesaid first embodiment of the active torque dispensing apparatus of the invention, the first actuating unit (3) lowers the output of the second output shaft (116) while the second actuating unit (4) lowers the output of the first output shaft (115). For instance, if the wheel vehicle turns excessively, the action time of the first actuating unit (3) or the second actuating unit (4) is determined by which one is connected to outer wheel in turning action. If the wheel tires connected to the first output shaft (115) are the outer wheels, then the second actuating unit (4) starts to act to lower output of the first output shaft (115) while if the wheel tires connected to the second output shaft (116) are the outer wheels, then the first actuating unit (3) starts to act to lower output of the second output shaft (116).

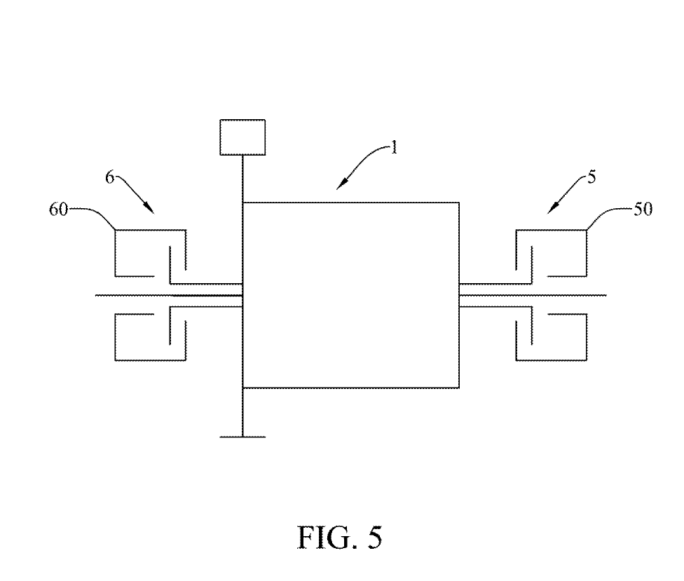

FIG. 5 is a schematic drawing of the active torque dispensing apparatus of the third embodiment of the invention. As shown in FIG. 5, the active torque dispensing apparatus of the third embodiment of the invention includes a differential (1), a first actuating unit (5) and a second actuating unit (6).

In the present embodiment, the differential (1) employs the active torque dispensing apparatus of the first embodiment, thereby it is declared here that all the numerals will be continued to use,

The first actuating unit (5) possesses a first power source (50) that is furnished at the second output shaft (116) as shown in FIG. 2 or FIG. 3. while the second actuating unit (6) possesses a second power source (60) which is furnished at the first output shaft (115) as shown in FIG. 2 or FIG. 3.

The action time of the first actuating unit (5) or the second actuating unit (6) is determined by the amount of the output torque. Assuming that the first actuating unit (5) can affect the output of the outer wheels in a turning action and the second actuating unit (6) can affect the output of the inner wheels in a turning action, in case the turning action is insufficient, the first actuating unit (5) tends to elevate the torque of the outer wheels in a turning action and the second actuating unit (6) tends to lower the torque of the inner wheels. On other hand, if the turning action is excessive, the first actuating unit (5) tends to lower the torque of the outer wheels in a turning action and the second actuating unit (6) tends to elevate the torque of the inner wheels.

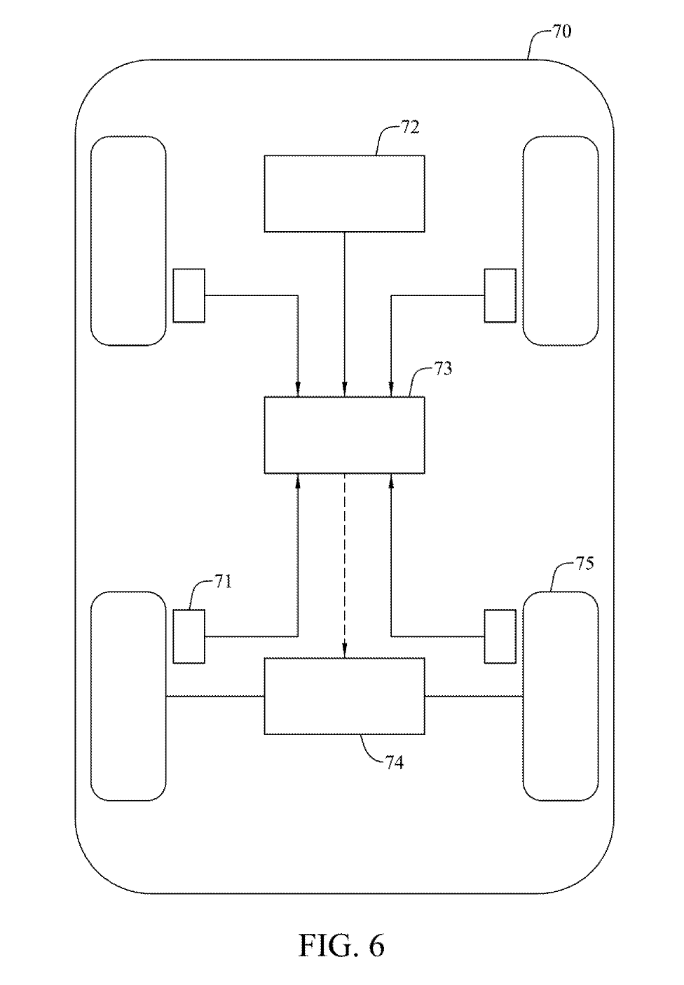

FIG. 6 is a schematic drawing of the active torque dispensing apparatus furnished at the vehicle body of the invention. As shown in FIG. 6, the active torque dispensing apparatus of the invention is furnished in a vehicle body (70) that has a wheel speed detecting unit (71) equipped at the position of the four wheels. The vehicle body (70) further equips with a steering wheel turning angle detecting unit (72) and a controlling unit (73). The controlling unit (73) is signally connected to the wheel speed detecting unit (71), the steering-wheel turning-angle detecting unit (72) and also to the active torque dispensing apparatus (74), which is connected to the two wheels (75) of the invention. Besides, the wheel speed detecting unit (71) can also be a wheel tire turning angle detector and the controlling unit (73) possesses a vehicle body turning-angle detector.

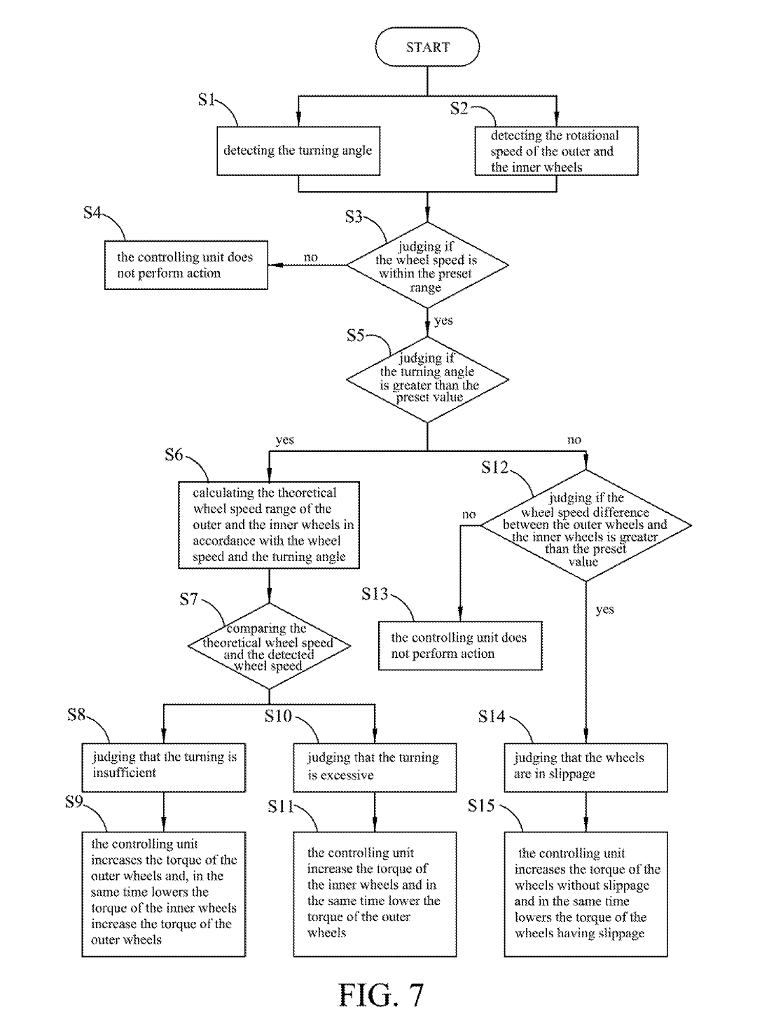

FIG. 7 is a flow chart showing the dispensing method of the active torque dispensing apparatus of the invention. As shown in FIG. 7, the dispensing method of the active torque dispensing apparatus of the invention including the following steps:

Step S1: detecting the turning angle. As shown in FIG. 6, the steering-wheel turning-angle detecting unit (72) is for detecting the turning angle of the steering wheel and transmitting its detected turning angle information to the controlling unit (73). As mentioned above, the steering-wheel turning-angle detecting unit (72) is for detecting the turning angle of the steering wheel.

Or, if the wheel speed detecting unit (71) being a wheel tire turning angle detector is for transmitting its detected turning angle information to the controlling unit (73). As mentioned above, the wheel speed detecting unit (71) is for detecting a wheel tire turning angle.

Or, the controlling unit (73) having wheel body turning angle detector is for detecting the turning angle of the wheel body and calculating a turning angle information. As mentioned above, the controlling unit (73) is for detecting a wheel body turning angle.

As mentioned above, the turning angle information can be a steering wheel turning information or a wheel tire turning angle information or a wheel body turning angle information.

Step S2: detecting the rotational speed of the outer and the inner wheels. Wheel speed detecting unit (71) is for detecting the wheel speed and transmitting the detected wheel speed information to the controlling unit (73).

Step S3: judging if the wheel speed is within the preset range. The controlling unit (73) is to judge if the wheel speed is within the preset range according to the wheel-speed information. If the judgment is NO, then proceed to Step S4, the controlling unit (73) does not perform any action. The preset range is a theoretical value which is obtained by calculating the vehicle speed and the rotating speed in accordance with the Ackermann steering geometry. For instance, the above mentioned actuating unit, i.e. the first actuating unit or the second actuating unit does not perform any action if the wheel rotating speed is lower than 265 rpm and the vehicle speed is lower than 20 km per hour.

If the judgment is YES, then the step proceeds to S5.

Step S5: judging if the turning angle is greater than the preset value. The controlling unit (73) judges if the steering wheel turning angle, the wheel tire turning angle or the vehicle body turning angle is greater than a preset value according to the turning angle information. The preset value is that the steering wheel turning angle, the wheel tire turning angle or the vehicle body turning angle is greater than 10 degrees.

If the judgment is YES, then the step proceeds to S6.

Step S6: calculating the theoretical wheel speed range of the outer and the inner wheels in accordance with the wheel speed and the turning angle. As depict in step S3, the theoretical wheel speed range is calculated by the Ackermann steering geometry.

Step S7: comparing the theoretical wheel speed and the detected wheel speed. For instance, the theoretical wheel speed is 265 rpm if the vehicle speed is lower than 20 km/hr while the theoretical wheel speed will be elevated accordingly if the vehicle speed is greater than 20 km/hr.

Step S8: judging that the turning is insufficient. If the turning is insufficient judged by the controlling unit (73), then proceed to Step S9.

Step S9: the controlling unit (73) increases the torque of the outer wheels and, in the same time lowers the torque of the inner wheels increase the torque of the outer wheels. AS shown in FIG. 1 and FIG. 5, if the actuating unit is the power source, it can provide a second power or a third power to elevate the torque of the outer wheels and lower the torque of the inner wheels. Or, if the actuating unit is a brake, then it can lower the torque of the inner wheels while the torque of the outer wheels can be elevated by the first power.

Step S10: judging that the turning is excessive. Following the step S7 as shown in FIG. 7, if the turning angle of the steering wheel is excessive judged by the controlling unit (73), then proceed to step S11.

Step S11: the controlling unit (73) increases the torque of the inner wheels and in the same time, lowers the torque of the outer wheels. As in FIG. 1 and FIG. 5, if the actuating unit is the power source, it can provide a second power or a third power to lower the torque of the outer wheels and elevate the torque of the inner wheels. Or, if the actuating unit is a brake, then it can lower the torque of the outer wheels while the torque of the inner wheels can be elevated by the first power.

Step S12: judging if the wheel speed difference between the outer wheels and the inner wheels is greater than the preset value. Following the step S5, if the judgment is NO, then proceed to step S12. The controlling unit (73) judges if the difference in wheel speed between the two side wheels (outer and inner wheels) is greater than a preset value. If the judgment is NO, then proceed to step S13.

Step S13: the controlling unit (73) does not perform action. If the judgment is of step S12 is YES, then proceed to step S14.

Step S14: judging that the wheels are in slippage, then proceed to step S15.

Step S15: the controlling unit (73) increases the torque of the wheels without slippage and in the same time lowers the torque of the wheels having slippage. As shown in FIG. 1 and FIG. 5, if the actuating unit is the power source, it can provide a second power or a third power to lower the torque of the wheels having slippage and elevate the torque of the wheels without slippage. Or, as shown in FIG. 4, if the actuating unit is a brake, then it can lower the torque of the wheels having slippage while the torque of the wheels without slippage can be elevated by the first power.

To summarize the above-mentioned depiction, if the first power source and the second power source are motors, the efficacy shown in the invention is as of the existing differential. If there are positive and reverse power outputs in the first power source and the second power source, as long as the first power source and the second power source provide the positive and reverse power in accordance with the requirements, the torque dispensation of both the output shafts can be adjusted.

In addition, the action timing of the first power source and the second power source is that the sense and magnitude of the output torque of the first power source and the second power source is determined by the turning angle of the steering wheel. Besides, by mean of the wheel speed signal to judge the wheel slippage on to feedback the first power source and the second power source to control the torque output.

What is more, the first brake and the second brake can aim at the power output of the first output shaft and the second output shaft. For instance, in case what is connected by the first output shaft is the outer wheel and what is connected by the second output shaft is the inner wheel, then the brake is furnished only at the first output shaft, and when the turning is excessive, the brake aims at the first output shaft to lower the torque of the outer wheels. If there are brakes furnished at both the first output shaft and the second output shaft when the above-mentioned condition varies, the brake can aim at the first output shaft or the second output shaft in accordance with the condition to change the torque of the outer wheels.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An active torque dispensing apparatus, comprising:
a differential; and
a first actuating unit furnished at the differential:
wherein the two ends of the differential is to output a first torque and a second torque, and the first actuating unit is to adjust the output of the first torque or the second torque.

2. The active torque dispensing apparatus as claimed in claim 1, wherein the first actuating unit possesses a first brake.

3. The active torque dispensing apparatus as claimed in claim 1, wherein the first actuating unit possesses a first power source.

4. The active torque dispensing apparatus as claimed in claim 1, wherein the first actuating unit possesses a first brake and a first power source.

5. The active torque dispensing apparatus as claimed in claim 3, wherein the first power source is a motor.

6. The active torque dispensing apparatus as claimed in claim 4, wherein the first power source is a motor.

7. The active torque dispensing apparatus as claimed in claim 1 further comprising a second actuating unit furnished at the differential.

8. The active torque dispensing apparatus as claimed in claim 7, wherein the second actuating unit possesses a second brake.

9. The active torque dispensing apparatus as claimed in claim 7, wherein the second actuating unit possesses a second power source.

10. The active torque dispensing apparatus as claimed in claim 7, wherein the second actuating unit possesses a second brake and a second power source.

11. The automatic guided vehicle as claimed in claim 9, wherein the second power source is a motor.

12. The automatic guided vehicle as claimed in claim 10, wherein the second power source is a motor.

13. The active torque dispensing apparatus as claimed in claim 1, wherein the differential possesses a gear train coupled with a power source.

14. The active torque dispensing apparatus as claimed in claim 13, wherein the power source is a motor or an engine.

15. The active torque dispensing apparatus as claimed in claim 13, wherein the gear train possesses a first input gear, a first center gear, first output gear, a second output gear, a first output shaft, a second output shaft and a second input gear; the first input gear is coupled with the power source, the first center gear is connected to the first input gear, the first output gear and the second output gear are engaged with the first center gear, the first output shaft being connected to the first output gear is protruded out of the differential, the second output shaft being connected to the second output gear is also protruded out of the differential, the second input gear being engaged with the first input gear is coupled with first actuating unit.

16. The active torque dispensing apparatus as claimed in claim 15, wherein the gear train further possesses a third input gear which is engaged with the first input gear.

17. The active torque dispensing apparatus as claimed in claim 16, wherein the gear train further possesses a second center gear which is engaged with the first output gear and the second output gear, and a balance gear which being connected to the second center gear is engaged with both the first output gear and the second output gear; the second center gear is engaged with both the third input gear and the second input gear.

18. An active torque dispensing apparatus, comprising:
a differential having a gear train which possesses a first input gear, a first center gear, a first output gear, a second output gear, a first output shaft, a second output shaft and a second input gear; the first input gear is engaged with the first center gear which is connected to the first input gear; both the first output gear and the second output gear are engaged with the first center gear; the first output shaft is connected to the first output gear; the second output shaft is connected to the second output gear; the second input gear is engaged with the first input gear;
a first actuating unit which is coupled with the second input gear;
wherein, the first output shaft outputs the first torque, the second output shaft outputs the second torque, the first actuating unit adjusts the first torque or the second torque.

19. The active torque dispensing apparatus as claimed in claim 18, wherein the first actuating unit possesses a first brake.

20. The active torque dispensing apparatus as claimed in claim 18, wherein the first actuating unit possesses a first power source.

21. The active torque dispensing apparatus as claimed in claim 18, wherein the first actuating unit possesses a first brake and a first power source.

22. The active torque dispensing apparatus as claimed in claim 20, wherein the first power source is a motor.

23. The active torque dispensing apparatus as claimed in claim 21, wherein the first power source is a motor.

24. The active torque dispensing apparatus as claimed in claim 18 further comprising a second actuating unit furnished at the differential.

25. The active torque dispensing apparatus as claimed in claim 24, wherein the second actuating unit possesses a second brake.

26. The active torque dispensing apparatus as claimed in claim 24, wherein the second actuating unit possesses a second power source.

27. The active torque dispensing apparatus as claimed in claim 25, wherein the second actuating unit possesses a second power source.

28. The active torque dispensing apparatus as claimed in claim 24, wherein the second actuating unit possesses a second power source and a second brake.

29. The automatic guided vehicle as claimed in claim 26, wherein the second power source is a motor.

30. The automatic guided vehicle as claimed in claim 27, wherein the second power source is a motor.

31. The automatic guided vehicle as claimed in claim 28, wherein the second power source is a motor.

32. The active torque dispensing apparatus as claimed in claim 18, wherein the gear train is engaged with a power source.

33. The active torque dispensing apparatus as claimed in claim 32, wherein the power source is a motor or an engine.

34. The active torque dispensing apparatus as claimed in claim 18, wherein the gear train further possesses a third input gear which is engaged with the first input gear.

35. The active torque dispensing apparatus as claimed in claim 34, wherein the gear train further possesses a second center gear and a balance gear which is connected to the second center gear and is engaged with both the first output gear and the second output gear; the second center gear is engaged with both the second input gear and the third input gear.

36. An active torque dispensing method, comprising the following steps:
detecting the turning angle;
detecting the rotating speed of both the outer and the inner wheels;
comparing the theoretical wheel speed and the detected wheel speed;
if the judgment is that the turning is insufficient, then proceed to a controlling unit to increase the torque for the outer wheels, and in the same time lower the torque for the inner wheels; and
if the judgment is that the turning is excessive, then proceed to a controlling unit to increase the torque for the inner wheels, and in the same time lower the torque for the outer wheels.

37. The active torque dispensing method as claimed in claim 36, wherein there is further a step, between the step for detecting the rotating speed of the outer wheels and the inner wheels, and the step for comparing the theoretical wheel speed and the detected wheel speed, for judging if the wheel speed is within the preset range; if the judgment is YES, then proceed to the step: judging if the turning angle is greater than the preset value; if the judgment is YES, then proceed to the step: calculating the theoretical wheel speed range of the outer and the inner wheels in accordance with the wheel speed and the turning angle.

38. The active torque dispensing method as claimed in claim 37, wherein the step: judging if the wheel speed difference between the outer wheels and the inner wheels is greater than the preset value, if the judging is NO, ten proceed to the step: the controlling unit does not perform action.

39. The active torque dispensing method as claimed in claim 37, wherein the step: judging if the turning angle is greater than the preset value, If the judgment is NO, then proceed to the step: judging if the wheel speed difference between the outer wheels and the inner wheels is greater than the preset value, if the judgment is YES, then proceed to the step: judging that the wheels are in slippage and to the step: the controlling unit increase the torque of the wheels without slippage and in the same time lower the torque of the wheels having slippage.

40. The active torque dispensing method as claimed in claim 37, wherein the step: judging if the wheel speed difference between the outer wheels and the inner wheels is greater than the preset value, if the judgment is NO, then proceed to the step: the controlling unit does not perform action.

41. The active torque dispensing method as claimed in claim 36, wherein the turning angle is the steering wheel turning angle, vehicle body turning angle or wheel tire turning angle.
